(19) United States
(12) Patent Application Publication
(10) Pub. No.: US 2026/0054425 A1
(43) Pub. Date: Feb. 26, 2026

(54) LARGE FABRICATION MOLDS

(71) Applicant: SOLVAY SPECIALTY POLYMERS USA, LLC, Alpharetta, GA (US)

(72) Inventor: Mohammad Jamal El-Hibri, Atlanta, GA (US)

(73) Assignee: SOLVAY SPECIALTY POLYMERS USA, LLC, Alpharetta, GA (US)

(21) Appl. No.: 18/849,416

(22) PCT Filed: Mar. 15, 2023
(86) PCT No.: PCT/EP2023/056643

§ 371 Date: Sep. 20, 2024

Related U.S. Application Data
(60) Provisional application No. 63/322,727, filed on Mar. 23, 2022.

(30) Foreign Application Priority Data
May 6, 2022 (EP) 22171948.7

(51) Int. Cl. B29C 33/40; B29C 33/38; B29C 64/118; B29K 71/00; B29K 81/00; B29K 507/04; B33Y 10/00; B33Y 70/00; B33Y 80/00

(52) U.S. Cl. CPC B29C 33/40; B29C 33/3842; B29C 64/118; B29K 2071/00; B29K 2081/06; B29K 2507/04; B33Y 10/00; B33Y 70/00; B33Y 80/00

(57) ABSTRACT

A mold for the molding of large articles is provided, said mold comprising at least one molding surface for receiving the material to be molded and which comprises at least one polyarylsulfone polymer, selected from poly(ethersulfone) and poly(biphenylsulfone), at least one poly(etherimide) polymer and a reinforcing carbon filler. The mold has good mechanical and thermal resistance properties.

### REFERENCE TO RELATED APPLICATIONS

This application claims priority from U.S. provisional patent application No. 63/322,727 filed on 23 Mar. 2022 and from EP patent application number 22171948.7 filed on 6 May 2022, the whole content of each of these applications being incorporated herein by reference for all purposes.

### TECHNICAL FIELD

The invention relates to molds for the molding of articles of large dimensions from plastic materials, including composite materials with continuous fibers.

### BACKGROUND ART

The invention relates to a mold for the molding of objects of large dimensions from plastic materials.

Molds for the manufacture of articles of large dimension are oftentimes made of metal. The replacement of metal with lighter weight plastic materials would bring several advantages in terms of overall cost and ease of manufacture. However several obstacles exist such as the thermal and mechanical resistance of the mold itself. In fact, molding of plastic or composite materials involves exposure of the mold to heating and cooling cycles, either by heating of the mold itself or by contacting the mold with the molten plastic material. This has the drawback that, during the following cooling down, deformations of the shape of the mold and changes of its dimensions occur, thus endangering the reproducibility of the moldings.

Thus, the need still exists for molds made of plastic materials which are suitable for the molding of articles of large dimensions having good thermal and mechanical resistance and low warpage.

### SUMMARY OF INVENTION

It has now been found that certain compositions comprising at least one polyarylsulfone selected from poly(ethersulfone) or poly(biphenylsulfone), at least one poly(etherimide) and a reinforcing carbon filler allow obtaining molds having large dimensions which are remarkably resistant to warpage.

Hence, a first object of the invention is a mold for the molding of articles, said mold comprising at least one molding surface for receiving the material to be molded and which comprises at least one polyarylsulfone polymer, selected from poly(ethersulfone) and poly(biphenylsulfone), at least one poly(etherimide) and a reinforcing carbon filler.

The inventive mold has mechanical properties, such as impact strength, tensile strength and tensile modulus, to meet the needs of the application, as well as high heat deflection temperature.

A second object of the invention is a method for making the mold using melt fabrication techniques, including injection molding, compression molding, as well as fused deposition type additive manufacturing techniques. The fused deposition type additive manufacturing techniques that can be employed include both filament based methods (fused filament fabrication, FFF) and large format fused deposition by direct extrusion.

A further object of the invention is a method for making a molded article using the mold of the invention.

### DESCRIPTION OF INVENTION

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

A first object of the invention is a mold for the molding of an article, said mold comprising at least one molding surface for receiving the material to be molded, said molding surface having a length in at least one direction of at least 1.0 m, wherein the mold comprises a composition (C) comprising:
0.5 to 40.0 wt % of at least one poly(etherimide) polymer;
0.0 to 70.0 wt % of at least one poly(biphenylsulfone) polymer;
0.0 to 70.0 wt % of at least one poly(ethersulfone) polymer; and
5.0 to 50.0 wt % of at least one reinforcing carbon filler, preferably a carbon fiber filler,
   characterised in that 10.0≤(X_{PPSU}+X_{PES})≤94.5 and X_{PPSU} and X_{PES} are not zero at the same time, wherein X_{PPSU} is the percent by weight of the at least one poly(biphenylsulfone) polymer in composition (C) and X_{PES} is the percent by weight of the at least one poly(ethersulfone) polymer in composition (C).

In the present specification all percentages by weight (wt %) are based on the total weight of the composition, unless expressly indicated otherwise.

The molding surface of the inventive mold typically has a length in at least one direction of at least 1.5 m, even of at least 2.0 m and/or up to 30 m or even up to 50 m. The molding surface may have a length in at least one direction of 1.0 to 30.0 m, even of 1.5 to 25.0 m, still of 3.0 to 20.0m.

The molding surface of the inventive mold may have a length in at least two directions which is of at least 1.0 m, even at least 1.5 m, still at least 2.0 m or more.

In certain embodiments, the molding surface has a length in two directions of 1.0 to 30.0 m, even 1.5 to 20.0 m.

The molding surface is generally contoured to the same shape as the article to be molded. It may have a convex or concave shape. The mold may comprise inserts as required by the article to be molded therein. In certain embodiments the mold may comprise more than one molding surface, for instance arranged to form a closed continuous surface.

The mold of the invention comprises composition (C) as detailed hereafter. Typically the molding surface of the inventive mold comprises composition (C). Preferably the mold is made of composition (C).

### Composition (C)

Composition (C) comprises:
0.5 to 40.0 wt % of at least one poly(etherimide) polymer, [polymer PEI] hereinafter;
0.0 to 70.0 wt % of at least one poly(biphenylsulfone) polymer, [polymer PPSU] hereinafter;

0.0 to 70.0 wt % of at least one poly(ethersulfone) polymer, [polymer PES] hereinafter; and
5.0 to 50.0 wt % of at least one reinforcing carbon filler,
   characterised in that 10.0≤(X_{PPSU}+X_{PES})≤94.5 and X_{PPSU} and X_{PES} are not zero at the same time, wherein X_{PPSU} is the percent by weight of the at least one poly(biphenylsulfone) polymer in composition (C) and X_{PES} is the percent by weight of the at least one poly(ethersulfone) polymer in composition (C).

For the avoidance of doubt, when X_{PPSU}=0 then X_{PES} #0 and when X_{PES}=0 then X_{PPSU}≠0.

Compositions (C) comprising:
0.5 to 40.0 wt % of at least one polymer PEI;
0.0 to 70.0 wt % of at least one polymer PPSU;
30.0 to 70.0 wt % of at least one polymer PES; and
5.0 to 50.0 wt % of at least one reinforcing carbon filler
   are also an object of the present invention.

In a first embodiment of the invention, composition (C) does not contain any polymer PPSU, that is 0.0 wt % of polymer PPSU or X_{PPSU}=0. In such an embodiment composition (C) comprises:
0.5 to 40.0 wt % of at least one polymer PEI;
40.0 to 70.0 wt % of at least one polymer PES; and
5.0 to 50.0 wt % of at least one reinforcing carbon filler.

In such an embodiment the amount of polymer PES may be at least 45.0 wt %, even 50.0 wt % based on the total weight of the composition.

Advantageous results were obtained with compositions (C) comprising: 3.0 to 15.0 wt % of at least one polymer PEI; 50.0 to 70.0 wt % of at least one polymer PES; and 15.0 to 50.0 wt % of at least one reinforcing carbon filler.

In another embodiment of the invention, composition (C) does not contain any polymer PES, that is 0.0 wt % of polymer PES or X_{PES}=0. In such an embodiment composition (C) comprises:
0.5 to 40.0 wt % of at least one polymer PEI;
30.0 to 65.0 wt % of at least one polymer PPSU; and
5.0 to 50.0 wt % of at least one reinforcing carbon filler.

In such an embodiment the amount of polymer PPSU may be at least 35.0 wt % based on the total weight of the composition.

Advantageous results were obtained with compositions (C) comprising: 5.0 to 40.0 wt % of at least one polymer PEI; 35.0 to 65.0 wt % of at least one polymer PPSU; and 15.0 to 50.0 wt % of at least one reinforcing carbon filler.

In a further embodiment, composition (C) comprises:
0.5 to 40.0 wt % of at least one polymer PEI;
5.0 to 70.0 wt % of at least one polymer PPSU;
30.0 to 70.0 wt % of at least one polymer PES; and
5.0 to 50.0 wt % of at least one reinforcing carbon filler.

Advantageous results were obtained with compositions (C) comprising: 5.0 to 20.0 wt % of at least one polymer PEI; 30.0 to 70.0 wt % of at least one polymer PES; 5.0 to 20.0 wt % of at least one polymer PPSU; and 15.0 to 50.0 wt % of at least one reinforcing carbon filler based on the total weight of the composition.

Composition (C) typically comprises at least 2.0 wt %, preferably at least 5.0 wt % of polymer PEI. The amount of polymer PEI is generally no more than 35.0 wt % based on the total weight of the composition.

Composition (C) typically comprises at least 10.0 wt % of the at least one reinforcing carbon filler, preferably at least 15.0 wt %. The amount of reinforcing carbon filler generally does not exceed 45.0 wt %. Good results in terms of reinforcing properties are generally obtained with an amount of reinforcing carbon filler in the range of 15.0 to 45.0 wt %, even 20.0 to 45.0 wt %.

### PEI Polymer

For the purpose of the present invention, a poly(etherimide) polymer, that is polymer PEI, is intended to denote any polymer of which more than 50 mol % of the recurring units (R_{PEI}) comprise at least one aromatic ring, at least one imide group, as such and/or in its amic acid form, and at least one ether group [recurring units (A)].

Recurring units (A) may optionally further comprise at least one amide group which is not included in the amic acid form of an imide group.

Recurring units (A) are advantageously selected from the group consisting of following formulae (I), (II), (III), (IV) and (V), and mixtures thereof:

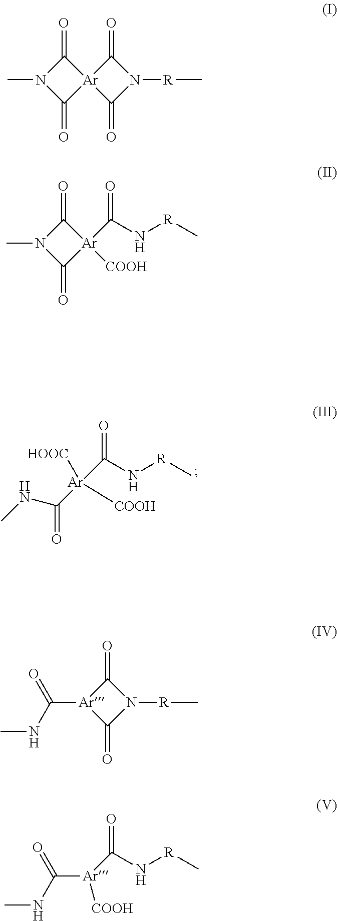

in which: Ar is a tetravalent aromatic moiety and is selected from the group consisting of a substituted or unsubstituted, saturated, unsaturated or aromatic monocyclic and polycyclic group having 5 to 50 carbon atoms; Ar′″ is a trivalent aromatic moiety and is selected from the group consisting of a substituted or unsubstituted, saturated, unsaturated or aromatic monocyclic and polycyclic group having 5 to 50 carbon atoms and R is selected from the group consisting of substituted or unsubstituted divalent organic radicals, and more particularly consisting of (a) aromatic hydrocarbon radicals having 6 to 20 carbon atoms and halogenated derivatives thereof; (b) straight or branched chain alkylene radicals having 2 to 20 carbon atoms; (c) cycloalkylene radicals having 3 to 20 carbon atoms, and (d) divalent radicals of the general formula (VI):

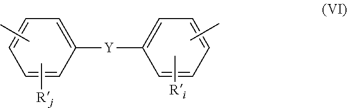

wherein Y is selected from the group consisting of alkylenes of 1 to 6 carbon atoms, in particular —C(CH₃)₂ and —Cₙ H₂ₙ— (n being an integer from 1 to 6); perfluoroalkylenes of 1 to 6 carbon atoms, in particular —C(CF₃)₂ and —Cₙ F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and R′ is selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and i and j equal or different from each other, are independently 0, 1, 2, 3 or 4. with the proviso that at least one of Ar, Ar′″ and R comprise at least one ether group wherein said ether group is present in the polymer chain backbone.

Preferably, Ar is selected from the group consisting of those complying with the following formulae:

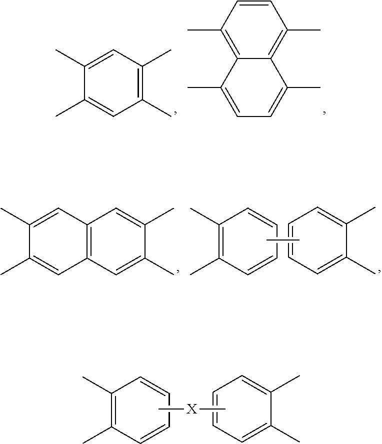

wherein X is a divalent moiety, having divalent bonds in the 3,3′, 3,4′, 4,3″ or the 4,4′ positions and is selected from the group consisting of alkylenes of 1 to 6 carbon atoms, in particular —C(CH₃)₂ and —Cₙ H₂ₙ— (n being an integer from 1 to 6); perfluoroalkylenes of 1 to 6 carbon atoms, in particular —C(CF₃)₂ and —Cₙ F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, or X is a group of the formula O—Ar″—O; and wherein Ar″ is selected from the group consisting of those complying with following formulae (VII) to (XIII), and mixtures thereof:

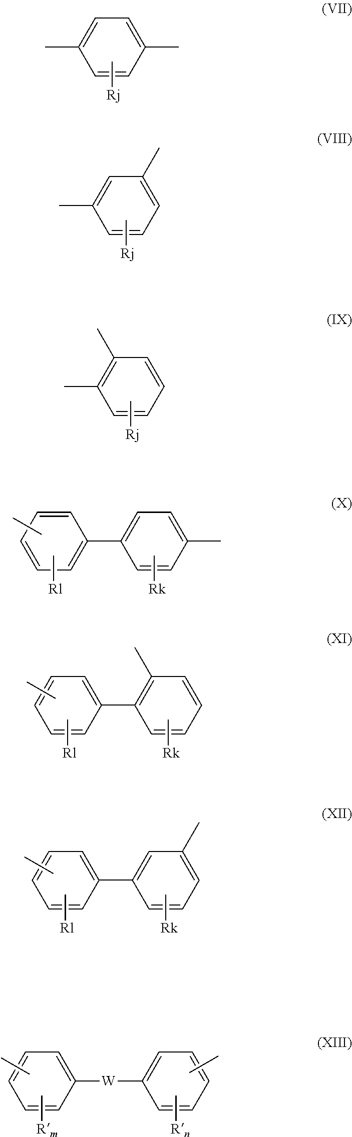

wherein R and R′, equal or different from each other, are independently selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j, k, l, n and m equal or different from each other, are independently 0, 1, 2, 3 or 4, and W is selected from the group consisting of alkylenes of 1 to 6 carbon atoms, in particular —C(CH₃)₂ and —CₙH₂ₙ— (with n being an integer from 1 to 6); perfluoroalkylenes of 1 to 6 carbon atoms, in particular —C(CF₃)₂ and —Cₙ F₂ₙ— (with n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; and —SO—.

Preferably, Ar′″ is selected from the group consisting of those complying with the following formulae:

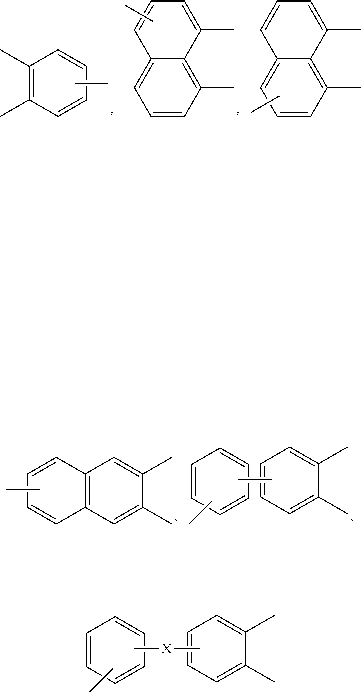

wherein X has the same meaning as defined above.

In a preferred specific embodiment, the recurring units (A) are selected from the group consisting of units of formula (XIV) in imide form, of corresponding units in amic acid forms of formulae (XV) and (XVI), and of mixtures thereof:

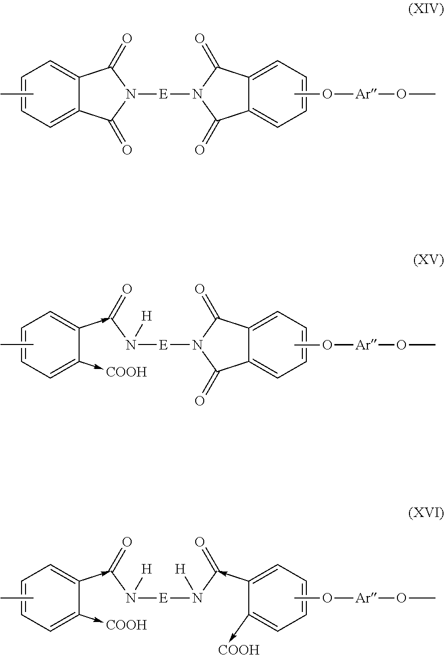

wherein:
the → denotes isomerism so that in any recurring unit the groups to which the arrows point may exist as shown or in an interchanged position;
   Ar″ is selected from the group consisting of those complying with following formulae (VII) to (XIII)

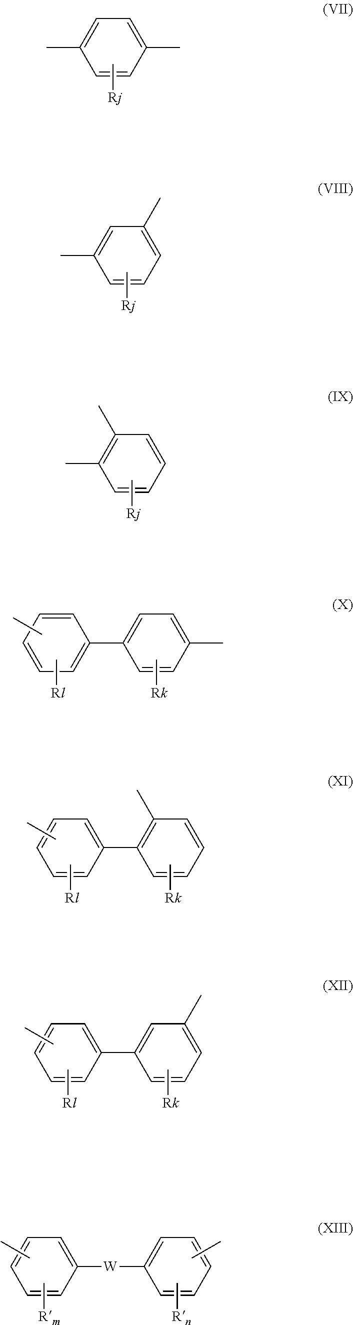

wherein R and R′, equal or different from each other, are independently selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j, k, l, n and m equal or different from each other, are independently 0, 1, 2, 3 or 4, and W is selected from the group consisting of alkylenes of 1 to 6 carbon atoms, in particular —C(CH₃)₂ and —CₙH₂ₙ— (n being an integer from 1 to 6); perfluoroalkylenes of 1 to 6 carbon atoms, in particular —C(CF₃)₂ and —Cₙ F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; and —SO—;
   E is selected from the group consisting of-CₙH₂ₙ— (n being an integer from 1 to 6), divalent radicals of the general formula (VI), as defined above, and those complying with formulae (XVII) to (XXII)

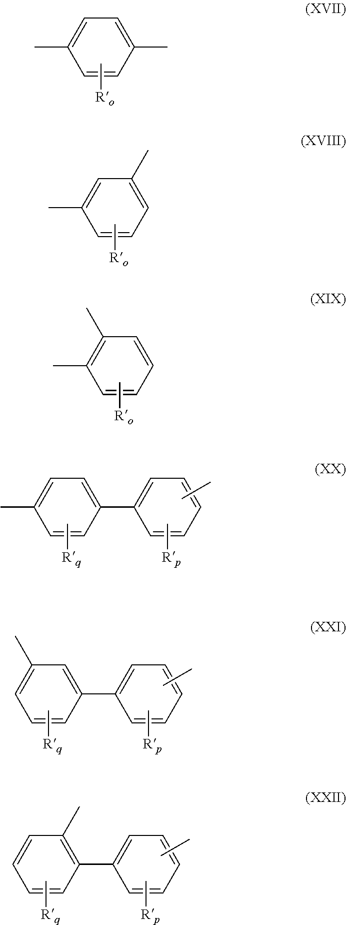

wherein R′ is selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and o, p, and q equal or different from each other, are independently 0, 1, 2, 3 or 4.

Preferably, E is selected from the group consisting of those complying with formulae (XVII) to (XIX), as defined above, more preferably, E is selected from the group consisting of unsubstituted m-phenylene and unsubstituted p-phenylene, and mixtures thereof.

Preferably, Ar″ is of the general formula (XIII), as detailed above; more preferably, Ar″ is

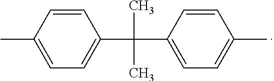

Polymers PEI wherein the recurring units (A) are recurring units of formula (XIV) as such, in imide form, and/or in amic acid forms [formulae (XV) and (XVI)], as defined above, may be prepared by any of the methods well-known to those skilled in the art including the reaction of any aromatic bis(ether anhydride)s of the formula

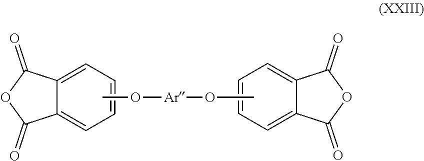

where Ar″ is as defined hereinbefore, with a diamino compound of the formula: H₂N-E-NH₂ (XXIV)
where E is as defined before.

Alternatively, these poly(etherimide) polymers can be prepared by melt polymerization of any dianhydrides of formula (XXIII) with any diamino compound of formula (XXIV) while heating the mixture of the ingredients at elevated temperatures with concurrent intermixing.

The aromatic bis(ether anhydride)s of formula (XXIII) include, for example: 2,2-bis[4-(2,3-dicarboxyphenoxy)phenyl]propane dianhydride; 4,4′-bis(2,3-dicarboxyphenoxy)diphenyl ether dianhydride; 1,3-bis(2,3-dicarboxyphenoxy)benzene dianhydride; 4,4′-bis(2,3-dicarboxyphenoxy)diphenyl sulfide dianhydride; 1,4-bis(2,3-dicarboxyphenoxy)benzene dianhydride; 4,4′-bis(2,3-dicarboxyphenoxy)benzophenone dianhydride; 4,4′-bis(2,3-dicarboxyphenoxy)diphenyl sulfone dianhydride; 2,2-bis[4 (3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 1,3-bis(3,4-dicarboxyphenoxy)benzene dianhydride; 1,4-bis(3,4-dicarboxyphenoxy)benzene dianhydride; 4,4′-bis(3,4-dicarboxyphenoxy)benzophenone dianhydride; 4-(2,3-dicarboxyphenoxy)-4′-(3,4-dicarboxyphenoxy)diphenyl-2,2-propane dianhydride; etc. and mixtures of such dianhydrides.

The organic diamines of formula (XXIV) include, for example, m-phenylenediamine, p-phenylenediamine, 2,2-bis(p-aminophenyl) propane, 4,4′-diaminodiphenyl-methane, 4,4′-diaminodiphenyl sulfide, 4,4′-diamino diphenyl sulfone, 4,4′-diaminodiphenyl ether, 1,5-diaminonaphthalene, 3,3′-dimethylbenzidine, 3,3′-dimethoxybenzidine, and mixtures thereof.

In a preferred embodiment, the organic diamines of formula (XXIV) is chosen from a group selected from m-phenylenediamine and p-phenylenediamine and mixture thereof.

In a most preferred embodiment, the recurring units (A) are recurring units selected from the group consisting of those of formula (XXV) in imide form, their corresponding amic acid forms of formulae (XXVI) and (XXVII), and mixtures thereof:

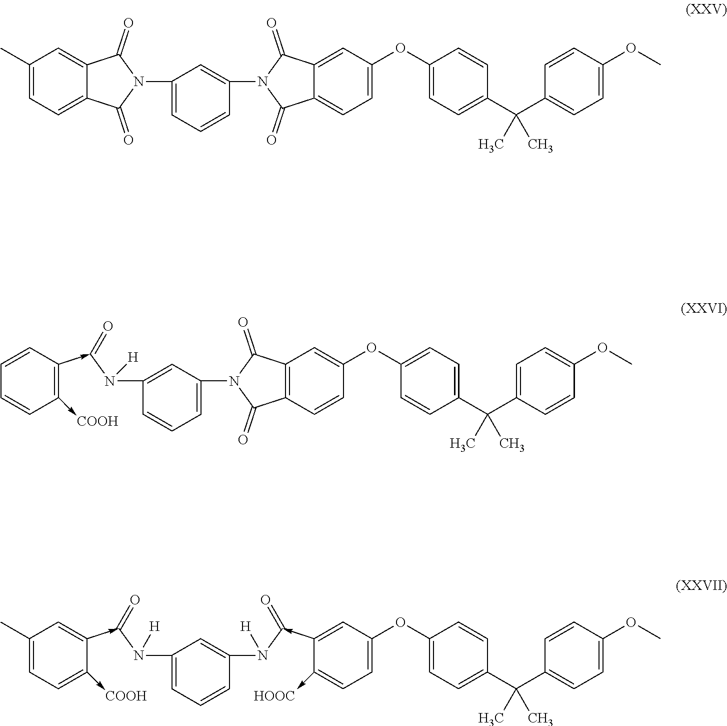

wherein in formulae (XXVI) and (XXVII) the → denotes isomerism so that in any recurring unit the two groups to which the arrows from the same aromatic ring point may exist as shown or in an interchanged position.

In another most preferred embodiment, the recurring units (A) are recurring units selected from the group consisting of those of formula (XXVIII) in imide form, their corresponding amic acid forms of formulae (XXIX) and (XXX), and mixtures thereof:

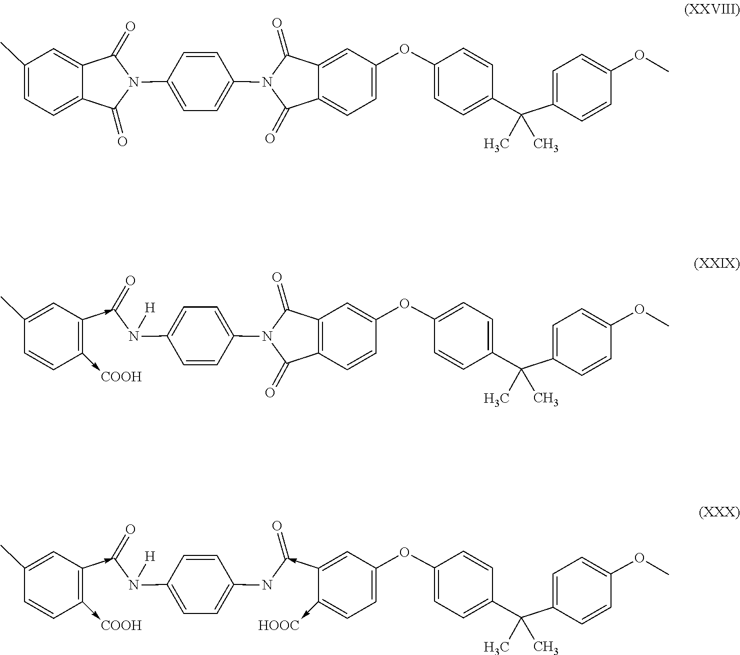

wherein in formulae (XXIX) and (XXX) the → denotes isomerism so that in any recurring unit the two groups to which the arrows from the same aromatic ring point may exist as shown or in an interchanged position.

Preferably more than 75 mol % and more preferably more than 90 mol % of the recurring units of polymer PEI are recurring units (A). Still more preferably, essentially all, if not all, the recurring units of the PEI are recurring units (A).

In a preferred embodiment of the present invention, more than 75 mol % more preferably more than 90 mol %, more preferably more than 99 mol %, even more preferably all the recurring units of the PEI are recurring units selected from the group consisting of those in imide form of formula (XXV), their corresponding amic acid forms of formulae (XXVI) and (XXVII), and mixtures thereof.

In another preferred embodiment of the present invention, more than 75 mol %, more preferably more than 90 mol %, more preferably more than 99 mol %, even more preferably all the recurring units of polymer PEI are recurring units selected from the group consisting of those in imide form of formula (XXVIII), their corresponding amic acid forms of formulae (XXIX) and (XXX), and mixtures thereof.

Suitable polymer PEI are commercially available from Sabic Innovative Plastics as ULTEM® poly(etherimide) polymers.

Composition can comprise one and only one polymer PEI or a mixture of more than one polymer PEI.

Generally, polymers PEI useful in the present invention have a melt flow rate (MFR) ranging from 0.1 to 40.0 grams per 10 minute, as measured according to ASTM D1238 at 337° C. and under a load of 6.6 kg, preferably ranging from 4 to 25 grams per 10 minute, as measured according to ASTM D1238 at 337° C. and under a load of 6.6 kg.

In a specific embodiment, polymer PEI has advantageously a weight average molecular weight (Mw) of 10,000 to 150,000 grams per mole (g/mole), as measured by gel permeation chromatography, using a polystyrene standard. Such polymers PEI typically have an intrinsic viscosity greater than 0.2 deciliters per gram (dl/g), beneficially 0.35 to 0.7 dl/g measured in m-cresol at 25° C.

### Polymer PPSU

The composition comprises at least one polymer PPSU. As used herein, polymer PPSU denotes any polymer comprising at least 50 mol % recurring units (R_{PPSU}) of formula (B), the mol % being based on the total number of moles of recurring units in the polymer:

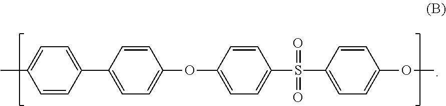

According to an embodiment of the present disclosure, at least 60 mol %, at least 70 mol %, at least 80 mol %, at least 90 mol %, at least 95 mol %, at least 99 mol % or all of the recurring units in the PPSU are recurring units (R_{PPSU}) of formula (B).

PPSU can be prepared by known methods and is notably available as RADEL® PPSU from Solvay Specialty Polymers USA, L.L.C.

The PPSU polymer has advantageously a melt flow rate (MFR) equal to or higher than 5 g/10 min at 365° C. and under a load of 5.0 kg, preferably equal to or higher than 10 g/10 min at 365° C. and under a load of 5.0 kg, more preferably equal to or higher than 14 g/10 min at 365° C. and under a load of 5.0 kg, as measured in accordance with ASTM method D1238.

Upper boundary for the melt flow rate of the PPSU polymer will generally be of at most 100 g/10 min, preferably at most 60 g/10 min, more preferably at most 40 g/10 min.

The PPSU polymer weight average molecular weight can be 20,000 to 100,000 grams per mole (g/mol) as determined by gel permeation chromatography according to ASTM D5296 using methylene chloride as a mobile phase and polystyrene standards. In some embodiments the PPSU polymer weight average molecular weight can be 40,000 to 80,000 grams per mole (g/mol). In other embodiments the PPSU polymer has a weight average molecular weight (Mw) ranging from 48,000 to 52,000 g/mol.

### Polymer PES

As used herein, poly(ethersulfone), polymer PES denotes any polymer of which at least 50 mol % of the recurring units are recurring units of formula (D):

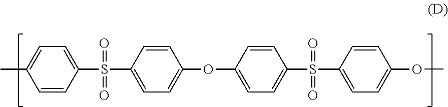

Preferably at least 60 mol %, 70 mol %, 80 mol %, 90 mol %, 95 mol %, 99 mol %, and most preferably all of the recurring units in the PES are recurring units of formula (D).

PES can be prepared by known methods and is notably available as VERADEL® PESU from Solvay Specialty Polymers USA, LLC.

The PES polymer has advantageously a melt flow rate (MFR) of at least 10 g/10 min as measured according to ASTM D1238 using a temperature of 380° C. and a weight of 2.17 kg. The MFR is more preferably greater than 15 g/10 min and most preferably greater than 20 g/10 min. The MFR will generally be at most 100 g/10 min, preferably at most 80 g/10 min and most preferably at most 60 g/10 min.

### Reinforcing Carbon Fillers

Composition (C) comprises at least one reinforcing carbon filler, preferably a carbon fiber filler.

For the purpose of the present invention, the term “carbon fiber filler” is intended to include graphitized, partially graphitized and ungraphitized carbon reinforcing fibers or a mixture thereof.

The term “graphitized” intends to denote carbon fibers obtained by high temperature pyrolysis (over 2000° C.) of carbon fibers, wherein the carbon atoms place in a way similar to the graphite structure.

Carbon fibers useful for the present invention can advantageously be obtained by heat treatment and pyrolysis of different polymer precursors such as, for example, rayon, polyacrylonitrile (PAN), aromatic polyamide or phenolic resin; carbon fibers useful for the present invention may also be obtained from pitchy materials.

Carbon fibers useful for the present invention are preferably chosen from the group composed of PAN-based carbon fibers (PAN-CF), pitch based carbon fibers, graphitized pitch-based carbon fibers, and mixtures thereof.

PAN-based carbon fibers (PAN-CF) have advantageously a diameter of between 3 to 20 μm, preferably from 4 to 15 μm, more preferably from 5 to 10 μm, most preferably from 6 to 8 μm. Good results were obtained with PAN-based carbon fibers (PAN-CF) having a diameter of 7 μm.

The PAN-CF maybe of any length. In general, the length of PAN-CF is at least 50 μm.

Graphitized pitch-based carbon fibers are readily available from commercial sources containing at least about 50 wt % graphitic carbon, greater than about 75 wt % graphitic carbon, and up to substantially 100 wt % graphitic carbon. Highly graphitic carbon fiber particularly suitable for use in the practice of this invention may be further characterized as highly conductive, and such fiber is generally used having a modulus of about 550 to about 830 GPa. In certain embodiments the highly graphitic carbon fiber has a modulus of about 590 to about 830 GPa, and in other certain embodiments about 690 to about 793 GPa.

The pitch-based-CF has advantageously a diameter between 5 to 20 μm, preferably from 7 to 15 μm, more preferably from 8 to 12 μm.

The pitch-based-CF may be of any length. The pitch-based-CF has advantageously a length of at least 50 μm.

### Additives

Composition can further include optional additives, including but not limited to, antioxidants (e.g. ultraviolet light stabilizers and heat stabilizers), processing aids, nucleating agents, lubricants, flame retardants, smoke-suppressing agents, anti-static agents, anti-blocking agents, colorants, pigments.

In some embodiments, antioxidants can be particularly desirable additives. Antioxidants can improve the heat and light stability of the composition. For example, antioxidants that are heat stabilizers can improve the thermal stability of the composition during manufacturing (or in high heat application settings), for example, by making the polymer processable at higher temperatures while helping to prevent polymer degradation.

When present, additives are contained in the composition in an amount typically not exceeding 10.0 wt %, even not exceeding 8.0 wt % with respect to the total weight of the composition. Additives are generally present in an amount of at least 0.5 wt %, for example at least 1.0 wt % with respect to the total weight of the composition.

Composition (C) can be prepared by melt compounding the powder mixture of the polymers and the fillers. Conventional melt compounding devices, such as co-rotating and counter-rotating extruders, single screw extruders, co-kneaders, disc-pack processors and various other types of extrusion equipment can be used. Preferably, extruders, more preferably twin screw extruders can be used.

It is advantageously possible to obtain strand extrudates of the composition (C) of the invention. Such strand extrudates can be chopped in the form of pellets or beads which can then be further used for the manufacture of the inventive mold.

A further object of the invention is a method for making the mold which is the first object of the invention. Any method which is suitable for manufacturing three dimensional articles having a length in at least one directions of at least 1.0 m from polymeric compositions may be used for making the inventive mold.

Suitable techniques may be for instance rotomolding or injection molding.

In a preferred aspect of the invention, the inventive mold is prepared by means of additive manufacturing techniques, preferably by means of fused deposition type additive manufacturing techniques. The fused deposition type additive manufacturing techniques that can be employed include both filament based methods (fused filament fabrication, FFF) and large format fused deposition by direct extrusion.

Hence, a further object of the invention is a method for making the mold of invention, the method comprising:
providing a part material comprising composition (C) as detailed above; and
depositing layers of the three-dimensional object from the part material.

The expression “part material” hereby refers to a blend of material, notably polymeric compounds, intended to form at least a part of the three dimensional object. The part material is according to the present disclosure used as feedstock to be used for the manufacture of three dimensional objects.

The part material may be in the form of a filament or microparticles.

The expression “filament” refers to a thread-like object or fiber formed of a material or blend of materials, in particular of composition (C). The expression “microparticles” refers to particles having a size comprised between 1 and 200 μm, for example between 10 and 100 μm or between 20 and 80 μm. Microparticles may be prepared for example by feeding composition (C) through a blade, a roll or an auger-pump print head.

According to an embodiment, the method of making a three-dimensional mold using an additive manufacturing system comprises a step consisting in extruding the part material. This step may for example occur when printing or depositing strips or layers of part material. The method of making 3D objects using an extrusion-based additive manufacturing system is also known as fused filament fabrication technique (FFF).

According to another fused deposition additive manufacturing technique, direct extrusion is utilized to create the strand by strand and layer by layer build of the part being produced without the use of a prefabricated filament. This technique, which often uses a vertically positioned extruder is referred to in the art as “big area additive manufacturing” (BAAM). It is a more practical technique for the additive manufacturing of parts that exceed 1.0 m in at least one direction, such as the molds that are the subject of this invention.

An additional object of the invention is a method of making an article comprising shaping a material on the molding surface of the inventive mold. Any known technique may be used for shaping a material on the molding surface of the mold, including coating, extrusion coatin or deposition of individual layers of materials.

The embodiments above are intended to be illustrative and not limiting. Additional embodiments are within the inventive concepts. In addition, although the present invention is described with reference to particular embodiments, those skilled in the art will recognize that changes can be made in form and detail without departing from the spirit and scope of the invention.

### EXAMPLES

The formulations and test data presented in this examples document illustrate the practice of this invention and demonstrate the unexpected benefits and utility of the invention. The examples are intended to illustrate the invention through selected embodiments without implying any limitation on its broad scope and generality.

### Starting Materials Used

Poly(biphenylsulfone): (PPSU) grade Radel® R-5600 NT available from Solvay Specialty Polymers. This grade has a melt flow rate of 31-40 g/10 min as measured per ASTM D1238 at 365 C and 5.0 kg weight.

Poly(ethersulfone) (PES) grades Veradel® 3300 also available from Solvay Specialty Polymers. This grade has a melt flow rate of 25-35 g/10 min as measured per ASTM D1238 using a temperature of 380° C. and 2.16 kg weight.

Poly(etherimide) (PEI), a high melt flow rate grade available as Ultem® 1010 from Sabic Innovative Plastics.

The carbon fiber reinforcement used was a chopped carbon fiber sold as Tenax® A P742 by Teijin.

Other additives included zinc oxide grade Activ® R-609, which was procured from Lanxess Corporation.

### Preparation of Formulations

The formulations of the examples were prepared by first tumble blending pellets or powders of the polymers making up the composition at the desired compositional ratios plus zinc oxide for about 20 minutes, followed by melt compounding using a 26 mm diameter Coperion ZSK-26 co-rotating partially intermeshing twin screw extruder having an L/D ratio of 48:1. The extruder had 12 barrel sections with barrel sections 2 through 11 being heated with set point temperature of 350° C. The die section was also set to a temperature of 350° C.

The polymers plus zinc oxide pre-blend was fed at barrel section 1 using a gravimetric feeder at nominal throughput rates ranging from 7.9 to 12.7 kg/hr while the carbon fiber reinforcement was fed to the extruder at barrel section 7 at the corresponding throughput rate to allow a carbon fiber load level of 30 weight % in all the finished compounds. The extruder was operated at a screw speed of about 200 rpm and vacuum venting was applied at barrel section 10 during compounding to strip off moisture and any possible residual volatiles from the compound. A single-hole die was used for all the compounds and the molten polymer strand exiting the die was cooled in a water trough and then cut in a pelletizer to form pellets approximately 3.0 mm in length by 2.7 mm in diameter. Comparative examples, which consisted of only one polymer in the formulation were also prepared similarly by feeding the polymer or polymer/zinc oxide mixture at barrel section 1 and the carbon fiber at barrel section 7 under the same conditions described above.

Injection molding was used to produce the test specimens for the measurement of mechanical properties and heat deflection temperature. 25 tensile and 25 flexural specimens were prepared from each composition. The tensile test specimens were 3.2 mm (0.125 in) thick type I ASTM tensile bars according to ASTM specification D638, and the flexural specimens were 127 mm×12.7 mm×3.2 mm dimensions. The mechanical test specimens were injection molded using the following approximate set point conditions which are in harmony with injection molding guidelines recommended by the suppliers for the different polymers: Rear barrel section: 680° F. (360° C.); Middle barrel section: 690° F. (365° C.); Front barrel section: 700° F. (371° C.); Nozzle: 700° F. (371° C.); Mold: 330° F. (165° C.);

### Testing

The following ASTM test methods were employed in evaluating all compositions:
D638: Tensile properties
D790: Flexural properties
D256: Notched Izod impact resistance
D4812: Unnotched Izod impact resistance
D648: Heat deflection temperature at 1.82 MPa

All tests except heat deflection temperature were carried out on test parts as molded. The heat deflection temperature test was conducted on annealed specimens using the annealing condition of 200° C. for 1 hour in a forced air oven.

The formulations of all the examples 1 to 5 and comparative examples 1 to 3, along with the corresponding mechanical evaluation results are shown in Table 1.

TABLE 1

| | CE1 | E1 | E2 | CE2 | E3 | E4 | E5 | CE3 |
|---|---|---|---|---|---|---|---|---|
| PES (wt %) | 69.9 | 62.9 | 55.9 | | — | — | | — |
| PPSU (wt %) | — | — | 7.0 | 69.9 | 62.9 | 52.4 | 35.0 | — |
| PEI (wt %) | — | 7.0 | 7.0 | | 7.0 | 17.5 | 34.9 | 69.9 |
| Carbon Fiber (wt %) | 30.0 | 30.0 | 30.0 | 30.0 | 30.0 | 30.0 | 30.0 | 30.0 |
| Zinc Oxide (wt %) | 0.10 | 0.10 | 0.10 | 0.10 | 0.10 | 0.10 | 0.10 | 0.10 |
| Tensile Breaking | 194 | 203 | 203 | 168 | 193 | 195 | 214 | 230 |
| Strength [MPa] | | | | | | | | |
| Tensile Modulus [GPa] | 24.1 | 24.6 | 24.6 | 21.8 | 23.3 | 22.8 | 23.6 | 25.2 |
| Tensile Elongation at | 1.4 | 1.5 | 1.5 | 1.4 | 1.3 | 1.5 | 1.5 | 1.3 |
| Break (%) | | | | | | | | |
| Flex Strength [MPa] | 279 | 295 | 301 | 237 | 270 | 282 | 301 | 324 |
| Flex Modulus [GPa] | 22.4 | 22.6 | 22.3 | 19.6 | 21.1 | 20.7 | 21.9 | 23.4 |
| Flex Strain at Break (%) | 1.58 | 1.69 | 1.78 | 1.55 | 1.58 | 1.78 | 1.69 | 1.62 |
| Notched Izod [J/m] | 53 | 63 | 66 | 50 | 50 | 53 | 53 | 57 |
| No Notch Izod [J/m] | 539 | 641 | 657 | 445 | 560 | 571 | 630 | 577 |
| HDT [annealed at 200° C.] | 224 | 221 | 221 | 217 | 212 | 214 | 216 | 215 |
| 1.82 MPa/3.2 mm thick | | | | | | | | |
| (° C.) | | | | | | | | |

The data show that the compositions of examples 1 to 5 exhibit a good balance of strength, modulus, impact resistance and heat deflection temperature. These property enhancements are expected to extend to long term properties of the inventive molds such as fatigue resistance and creep rupture resistance. The high heat deflection temperature of the compositions of examples 1 to 5, together with their good mechanical properties, makes them particularly suitable for use in molds for the shaping of thermoplastic composite materials where processing temperatures can be as high as 200° C.

1. A mold for the molding of an article, said mold comprising at least one molding surface for receiving the material to be molded, said molding surface having a length in at least one direction of at least 1.0 m, wherein the mold comprises a composition (C) comprising:
0.5 to 40.0 wt % of at least one poly(etherimide) polymer;
0.0 to 70.0 wt % of at least one poly(biphenylsulfone) polymer;
0.0 to 70.0 wt % of at least one poly(ethersulfone) polymer; and
5.0 to 50.0 wt % of at least one reinforcing carbon filler,
characterised in that 10.0≤(X_{PPSU}+X_{PES})≤94.5 and X_{PPSU} and X_{PES} are not zero at the same time, wherein X_{PPSU} is the percent by weight of the at least one poly(biphenylsulfone) polymer in the composition (C) and X_{PES} is the percent by weight of the at least one poly(ethersulfone) polymer in the composition (C).

2. The mold of claim 1 wherein the molding surface has a length in at least two directions of at least 1.0 m and/or up to 50.0 m.

3. The mold of claim 1 in which the composition (C) comprises:
0.5 to 40.0 wt % of at least one poly(etherimide) polymer;
0.0 to 70.0 wt % of at least one poly(biphenylsulfone) polymer;
30.0 to 70.0 wt % of at least one poly(ethersulfone) polymer; and
5.0 to 50.0 wt % of at least one reinforcing carbon filler.

4. The mold of claim 1 in which composition (C) comprises:
0.5 to 40.0 wt % of at least one poly(etherimide) polymer;
10.0 to 70.0 wt % of at least one poly(biphenylsulfone) polymer;
0.0 to 70.0 wt % of at least one poly(ethersulfone) polymer; and
5.0 to 50.0 wt % of at least one reinforcing carbon filler.

5. The mold of claim 1 in which the composition (C) comprises 5.0 to 35.0 wt % of at least one poly(etherimide) polymer and/or 15.0 to 45.0 wt % of at least one reinforcing carbon fiber filler.

6. The mold of claim 1 in which the at least one poly(etherimide) polymer comprises more than 50 mol % of the recurring units, based on the total number of moles of recurring units in the polymer, which are selected from the group consisting of those of formula (XXV) in imide form, their corresponding amic acid forms of formulae (XXVI) and (XXVII), and mixtures thereof: 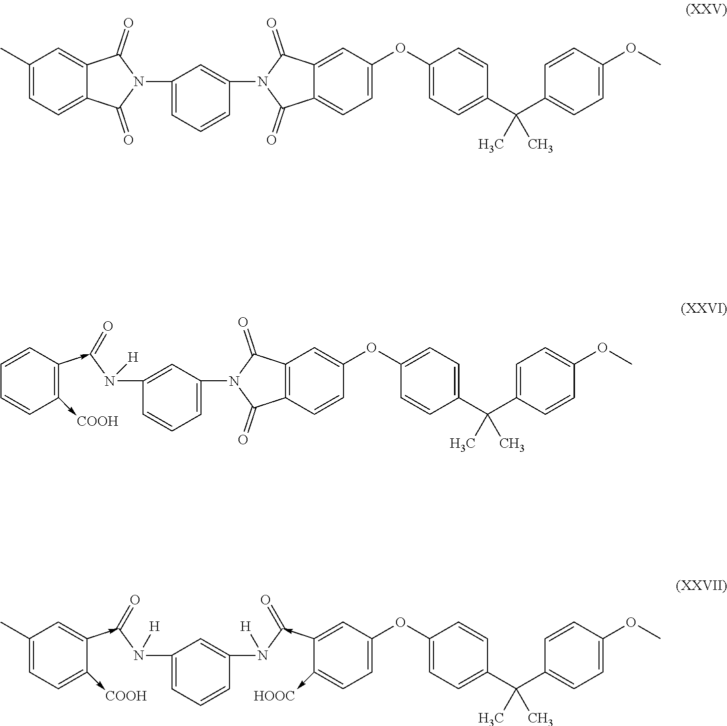
wherein in formulae (XXVI) and (XXVII) the → denotes isomerism so that in any recurring unit the two groups to which the arrows from the same aromatic ring point may exist as shown or in an interchanged position.

7. The mold of claim 1 in which the at least one poly(biphenylsulfone) polymer comprises at least 50 mol % of recurring units of formula (B), the mol % being based on the total number of moles of recurring units in the polymer:

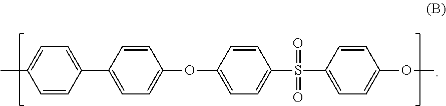

8. The mold of claim 1 in which the at least one poly(ethersulfone) polymer comprises at least 50 mol % of recurring units of formula (D), the mol % being based on the total number of moles of recurring units in the polymer:

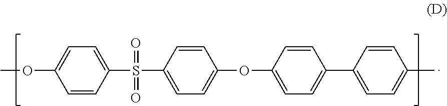

9. The mold of claim 1 in which the carbon fiber filler is selected from the group consisting of PAN-based carbon fibers (PAN-CF), pitch based carbon fibers, graphitized pitch-based carbon fibers, and mixtures thereof.

10. A method for making the mold of claim 1 the method comprising:
providing a part material comprising the composition (C), and
depositing layers of a three-dimensional object from the part material.

11. The method of claim 10 wherein the part material is in the form of a filament or microparticles.

12. The method of claim 10 wherein the step of depositing layers comprises extruding the part material.

13. A method for making an article comprising shaping a material on the at least one molding surface of the mold of claim 1.

14. A composition (C) comprising:
0.5 to 40.0 wt % of at least one poly(etherimide) polymer;
0.0 to 70.0 wt % of at least one poly(biphenylsulfone) polymer;
30.0 to 70.0 wt % of at least one poly(ethersulfone) polymer; and
5.0 to 50.0 wt % of at least one reinforcing carbon filler.

15. The Composition (C) of claim 14 in which the at least one poly(etherimide) polymer comprises more than 50 mol % of the recurring units, based on the total number of moles of recurring units in the polymer, which are selected from the group consisting of those of formula (XXV) in imide form, their corresponding amic acid forms of formulae (XXVI) and (XXVII), and mixtures thereof: 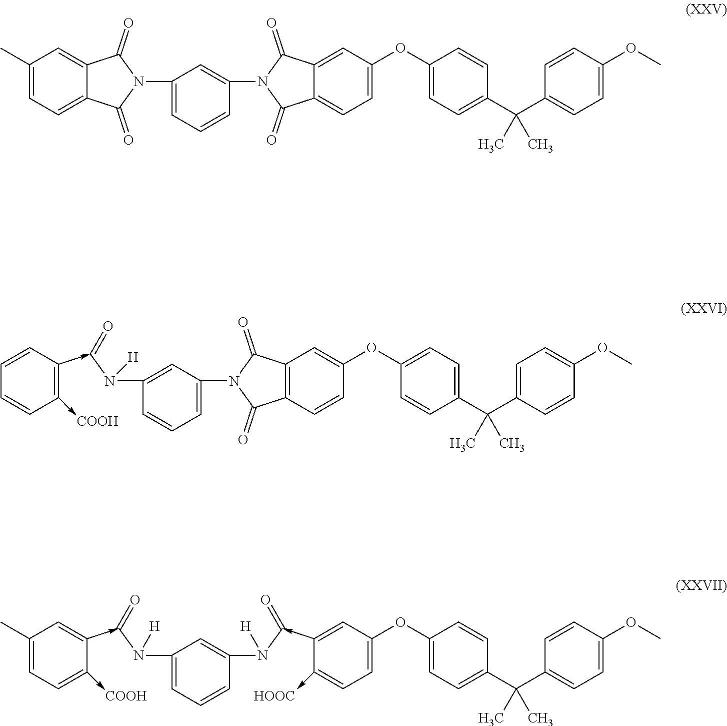
wherein in formulae (XXVI) and (XXVII) the → denotes isomerism so that in any recurring unit the two groups to which the arrows from the same aromatic ring point may exist as shown or in an interchanged position.

16. The Composition (C) of claim 14 in which the at least one poly(biphenylsulfone) polymer comprises at least 50 mol % of recurring units of formula (B), the mol % being based on the total number of moles of recurring units in the polymer:

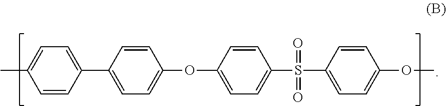

17. The Composition (C) of claim 14 in which the at least one poly(ethersulfone) polymer comprises at least 50 mol % of recurring units of formula (D), the mol % being based on the total number of moles of recurring units in the polymer:

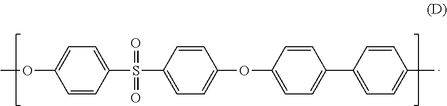

18. The Composition (C) of claim 14 in which the carbon fiber filler is selected from the group consisting of PAN-based carbon fibers (PAN-CF), pitch based carbon fibers, graphitized pitch-based carbon fibers, and mixtures thereof.
